(19) United States
(12) Patent Application Publication
(10) Pub. No.: US 2004/0224660 A1
(43) Pub. Date: Nov. 11, 2004

(54) Disposable cellular telephone with system of operation

(76) Inventor: Susan Jill Anderson, Elizabethton, TN (US)

Correspondence Address: Susan J. Anderson, 259 Ollie Collins Rd., Elizabethton, TN, 37643, US

(21) Appl. No.: 10/431,775

(22) Filed: May 8, 2003

(51) Int. Cl. H04M 11/00

(52) U.S. Cl. 455/406; 455/404.1; 455/432.1

(57) ABSTRACT

A telecommunications system incorporates individual station instruments simplified by disposable wireless instruments, pushbutton and coded dialing, prepaid airtime usage with simple accounting required, all enabled by cooperative system operation including supporting central equipment. Wireless operation of the central equipment involves a multiple port wireless platform along with other units for interfacing with a multitude of mobile station instruments simultaneously. Calling capabilities with two-way communication bridging through the public switched telephone network. Message capability, emergency abort to an operator and/or 911 station and security features supplement the basic system. With prior art prepaid and disposable telephone technology, there is not a workable system in place. This invention addresses those issues.

There is a preconceived account for which phones would be programmed through along with a specific time allotment and a sub-account number code utilizing a predetermined number and access code to prevent theft and/or fraud of time built into each disposable phone. The number assigned to each phone would utilize the prescribed area code pertaining to the area it is purchased from and the typical seven-digit telephone number. Due to a binary code engaged to each ten-digit number, there would be quick recycling capabilities of phone numbers.

Instruments are disposable with intention of being disposable upon distribution and purchase with recycling of enclosed wireless telephone charger and battery with original purchase of disposable telephone for future disposable telephone purchases. This ability of being disposable is made possible by constructing the disposable phones of recycled, lightweight materials similar to those materials use in toy telephone equipment and as mentioned in prior art of disposable or dispensable wireless telephones.

### OTHER REFERENCES

References

| | | | |
|---|---|---|---|
| 5454713 | Oct. 3, 1995 | Lee | |
| D381348 | Jul. 22, 1997 | Tanaka | |
| 5541977 | Jul. 30, 1996 | Hodges et al. | 379/58 |
| 5778313 | Jul. 7, 1998 | Fougnies et al. | 455/406 |
| 5815807 | Sep. 29, 1998 | Osmani | |
| 5875393 | Feb. 23, 1999 | Altschul et al. | |
| 6076000 | Jun. 13, 2000 | Lee | |
| 6112077 | Aug. 29, 2000 | Spitaletta et al. | |
| 6149353 | Nov. 21, 2000 | Nilsson | 455/409, 560 |
| 6208851 | Mar. 27, 2001 | Hanson | 455/405 |
| 6332074 | Dec. 18, 2001 | Spitaletta et al | |
| 6337903 | Jan. 8, 2002 | Maner et at. | 379/111 |
| D455139 | Apr. 2, 2002 | Shirley | D14/138 |

“Cellular carriers Use Prepaid Programs to Reach Untapped Markets” Billing World March 1997 pp. 14-17.

### FIELD OF THE INVENTION

The disposable telephone of the invention relates to wireless, digital, and cellular telephones which are also included with inexpensive cellular technology such as prepaid cellular telephones and telephones with dispensable instruments, with a system of operation that includes everything from the basic design of the telephone to the system of use and distribution.

### BACKGROUND OF THE INVENTION

The aforementioned invention relates to mobile telecommunication and more specifically, to wireless, prepaid telephone systems which include instruments that are compact, simple and inexpensive with the original addition of being disposable, and are part of an integral system operation in combination with enhanced central station equipment. The phones are enhanced with a predetermined amount of time, using a general account, and then progressing through the necessary channels to complete outgoing and have the option of receiving incoming calls. There are many wireless, digital and cellular phone capabilities in existence, including the pre-paid cellular telephone system. However, these systems require credit checks, oftentimes deposits, high phone rates, and lengthy, cumbersome contracts. The process for obtaining time is often difficult, as well as expensive. The invention eliminates, or at least gives options to, those who either are unable to obtain a standard cellular phone contract, or simply do not want the above-mentioned situations.

The invention also gives options and reaches out to an untapped market in the world of cellular telephones. The ease and convenience of going to the market place, purchasing a telephone for an adequate fee off the rack, and then following the simple instructions enclosed in the telephone packaging. By utilizing the 1-800 number and then setting up the activation of the telephone using the generalized accounting procedures prescribed specifically for these phones, one may prepare the phone for use. The invention contains a pre-designed mode of operation—preferably through an automated system complete with a subaccount number and/or code and pre-established minutes. It is an affordable system requiring no contracts and containing access to the 911 system also (whether dialed manually or through a special preprogrammed mode.) There is a backup to the automated help system communication with a customer service representative if necessary. The 1-800 number is available for determining minutes remaining in the predesignated block of time. Upon use of all minutes, all calls are terminated and the phone is disposed of properly. This phone is designed for short-term purposes in contrast to the prior art cellular telephone industry. The fear of theft or loss is virtually eliminated due to the inexpensive and disposable nature of the telephone.

### SUMMARY OF THE INVENTION

The disposable telephone system of the invention includes some prior art devices, yet creates a system of operation that is lacking at this time. There are drawings that pertain to the basic design, even though there is a vast array of possibilities, and even includes a system of operation and as well as a system of distribution. The means of power and charging the disposable telephone of the invention by means of a recyclable battery and charger are also included in the details throughout the invention. The aforementioned system includes such issues as start to end development of the distribution and “how this can actually work.”

Upon purchase of telephone of invention, telephone is charged, activated, and used with explanations of how these criteria are achieved. Telephone is completely disposable with exception of enclosed battery and charger which may be used in future disposable telephone purchases.

### BRIEF DESCRIPTION OF DRAWINGS

Following will be a more complete description by way of example with reference to the attached drawings, in which:

FIG. 1 shows a simple example of basic cellular telephone used in the invention.

FIG. 2 shows a general activation and time usage for persons who have purchased one of the telephones.

FIG. 3 illustrates the method of distribution of individual disposable telephones.

FIG. 4 shows the prior art of outgoing calls;

FIG. 5 shows the system involved with sending outgoing calls according to the invention;

FIG. 6 shows the prior art of an incoming call;

FIG. 7 reveals the description of assembling a phone system of incoming calls according to the invention.

FIG. 8 illustrates a detailed description of process beginning with the purchase of disposable telephone to the disposal of the telephone.

### DETAILED DESCRIPTION OF THE INVENTION

Referring to the attached drawings, a detailed description of the methods and apparatus regarding the present invention. However, the Figures representing the invention are strictly representative due to the many components that are possible. The ones prescribed in this invention maintain the example that best suits the extent of the invention.

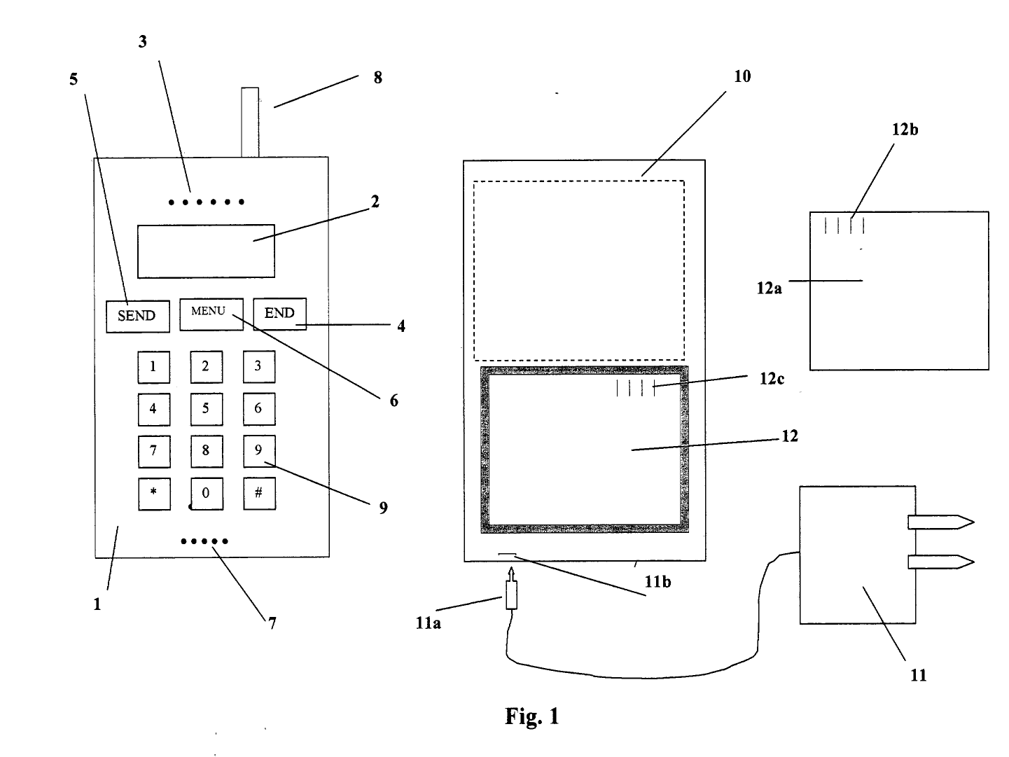

Refer to FIG. 1 which are drawings of a basic cellular phone comprised of the frontside being upright rectangular housing 1, menu display panel 2, antennae 8, receiver 3, speaker 7, end 4, send 5, menu 6, and standard numerical keypad 9 all found in existing technology, good representation of the type of telephone that will be used in the invention. The backside of the telephone 10 shows the battery compartment 12 that holds the reusable battery 12a. The reusable charger 11 included in the original purchase of disposable telephone of the invention is like those found in prior art prepaid wireless telephones. The battery prongs 12b line up with the battery conductors 12c in the rear housing of the battery compartment 12. The reusable charger 11 connects the adaptor plug 11a into adaptor entry insertion site 11b. The materials used in FIG. 1 are of inexpensive, lightweight, recycled materials whenever possible and comprised of technology already in existence such as on/off capabilities, process of sending or receiving wireless phone calls, and reception. The telephone is ready for use when backside of telephone 10 opened and enclosed battery 12a inserted in battery compartment 12. After proper activation and charging are achieved, the phone is ready for use.

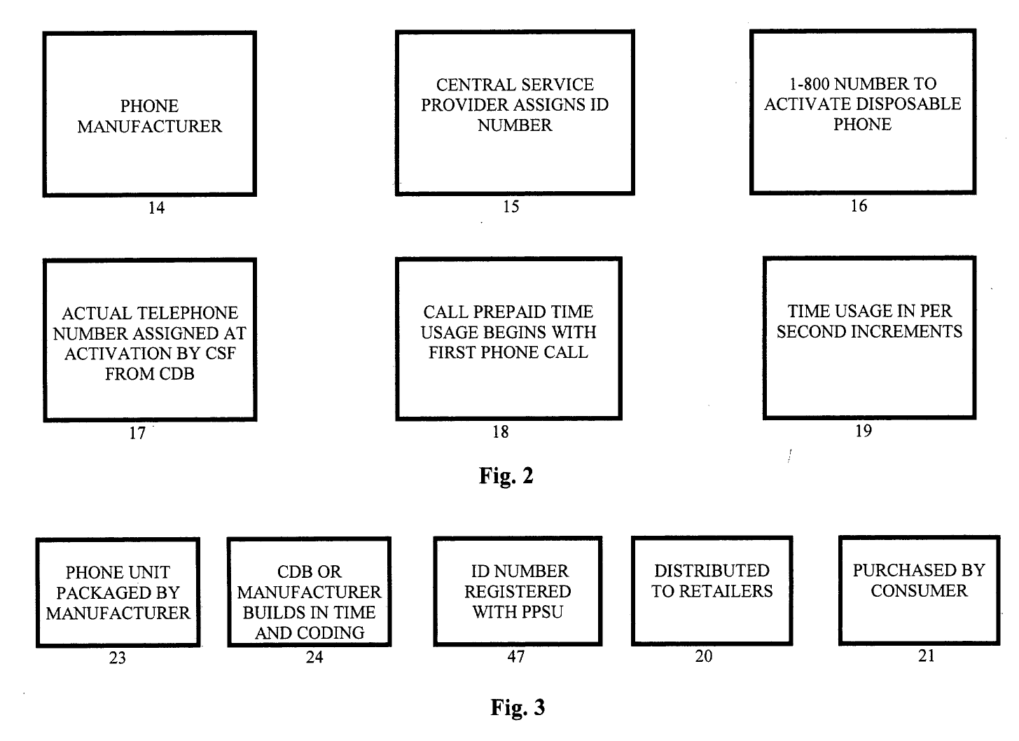

Referring to FIG. 2 shows a path for the general activation and time usage of each individual phone. Each phone manufacturer 14 that produces the disposable phone has a specifically designated pool of identification numbers 15, which are assigned to these particular phones. When the 1-800 number is called to activate the telephone 16, this I.D. number informs the Central Data Bank (CDB) 17 that a phone has been purchased. The actual telephone number given to a particular disposable phone is assigned when time is accessed originally after user through the CDB 17 has initiated service. This prevents telephone numbers from being held inactive for long periods of time. The time of the first phone call begins usage of predetermined amount of time 18. For example, if the phone has a preprogrammed amount of thirty minutes, the time is used with a minimum per second increment 19 to be designated by each manufacturer or distributor. Requesting amounts of time left on phone is as in the prior art prepaid phone through a link that also informs the consumer when time is low on said phone.

Referring to FIG. 3 illustrates a description of the distribution of the disposable phones. These phones are packaged by the manufacturer 23 in the least expensive method of packaging, while maintaining the integrity of each individual phone prior to purchase and opening. The disposable phones of the invention has all coding and time capabilities built in 24 using the duplex base ten/binary numbering system unique to each individual code assigned to each phone, or by using specialized scanning equipment which has been a theft-relate problem with the cellular, digital or wireless telephones of prior art. The CDB registers with Prepaid Phone Service Unit 47 the identification number of each particular phone. The disposable phones are then distributed to various retailers 20 where they may be purchased 21.

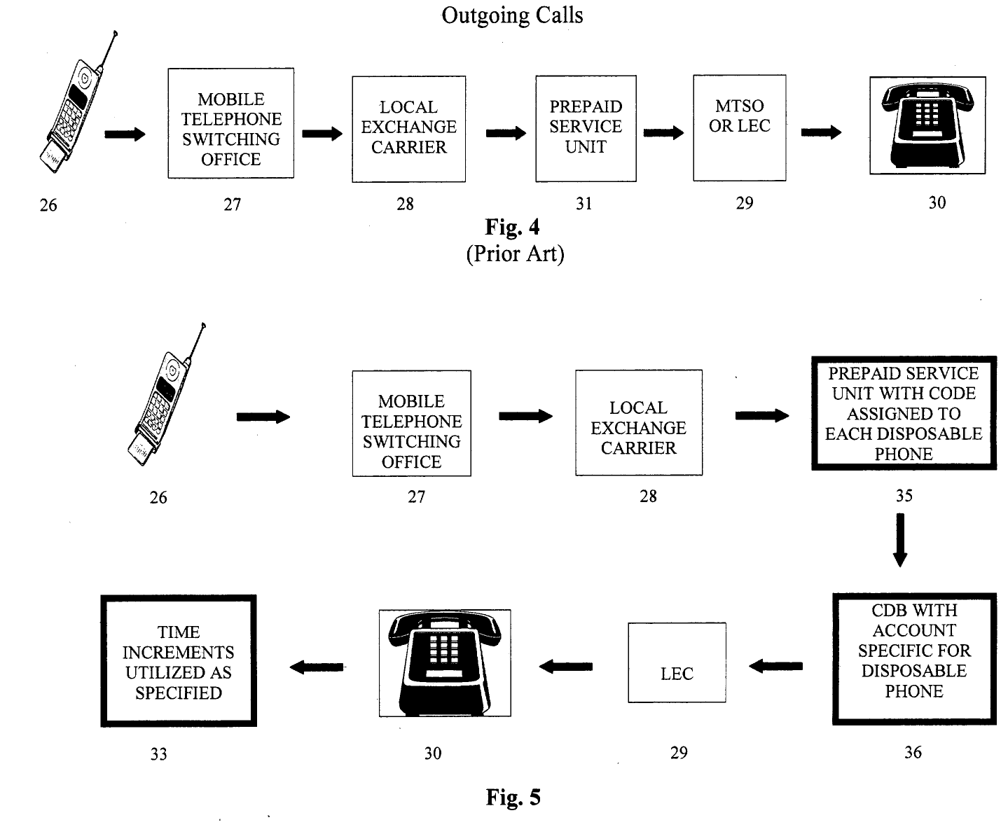

Referring to FIG. 4 is an illustration of the prior art of outgoing calls in typical cellular telephone systems. A call is originated from a cellular phone 26 going to its assigned Mobile Telephone Switching Office 27 at which point the call is forwarded to the Local Exchange Carrier 28 and then to the next MTSO or LEC 29 to destination of desired phone call 30. For both incoming and outgoing calls, the PPSU 31 of prior art interrupts the path of the call and converts the dialed number into a second number for completing each call. The PPSU 31 is separate from the MTSO and connected in the system among landlines or cellular connections already in place.

FIG. 5 illustrates the route of the outgoing phone call as pertaining to the invention. A call is originated from the phone 26 represented in the invention and proceeds forth as in the aforementioned FIG. 4, going through the MTSO 27 and LEC 28. At this time, it is intercepted by the PPSU that initiates the code process specified for each disposable phone 35. It then trunks through the CDB with a generalized account designated specifically for the disposable phones number 30. Upon answering the call of the disposable telephone of the invention, the predetermined increments of time are used until completion of that particular phone call 33 or minutes utilized completely.

Referring to FIG. 6 is an illustration of the prior art of incoming calls of cellular telephones. This begins with a telephone call originating from a second party 30 known as incoming call to the cellular telephone unit 26; the call originating from second party 30 proceeds through LEC 28 to PPSU 31 to LEC 28 of disposable telephone to MTSO 27 and ends with the answering of the telephone by individual prepaid disposable telephone 26. Increments of time are deducted accordingly 33.

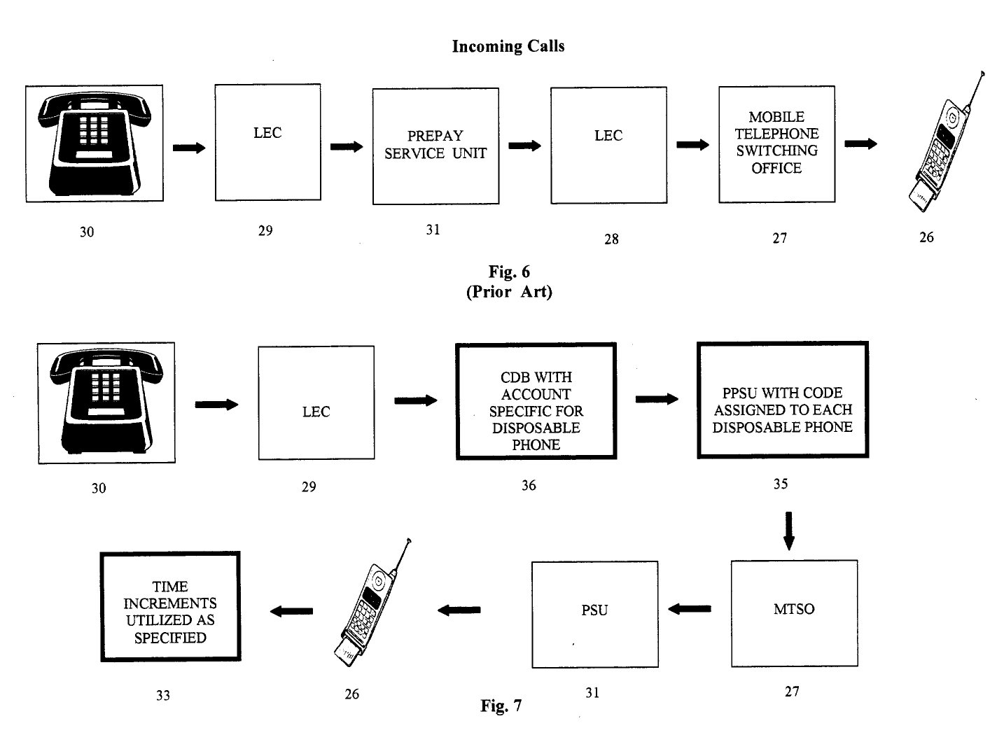

Referring to FIG. 7 illustrates a description of assembling the system of the incoming calls of the disposable cell phone. Beginning with a call from a second party 30, the call proceeds through the LEC 29 to the CDB with general accounting information 36 which then proceeds to use the code number assigned to the disposable telephone 35; this is forwarded to the appropriate MTSO 27 and to the recipient of the call which is the disposable telephone unit originally dialed 26. Upon acceptance of call by owner of disposable phone 26 the PPSU 31 after detecting available time left on disposable phone unit, begins deducting time 33 until phone call ends or time left on disposable phone unit runs out.

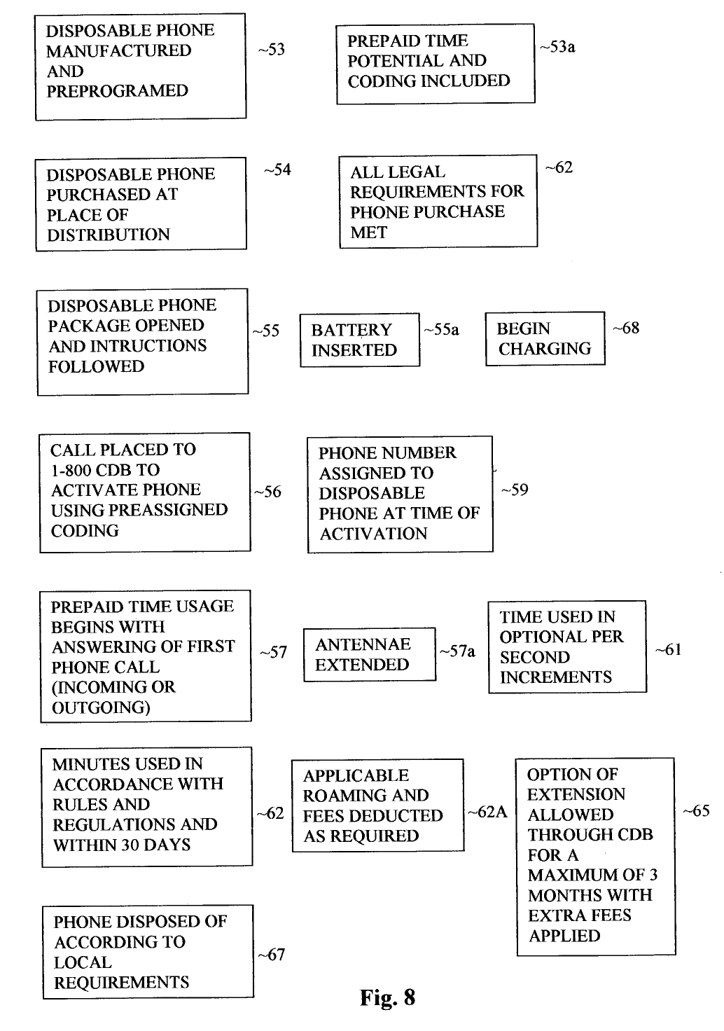

Referring to FIG. 8 is an illustration of the process that occurs when a disposable telephone is manufactured and prepared for purchase from a distributor 54 to the disposal of the telephone 67. After reading the instructions included in the packaging with the phone of the invention 55 and all rules, regulations, or legal requirements followed as necessary 62, the purchaser may continue with activation process at that time. After disposable phone package is opened, battery 12a is inserted and charging begins with reusable adaptor 11 included with the initial purchase as previously mentioned. Phone should be available at time of activation 56, antennae extended 57a, and any other mechanism required in the production of the proper currents necessary to have cellular telephone service of prior art and the invention. A call is then placed at this time to the 1-800 number 58 assigned to the particular disposable telephone, or a 3-digit service number as is used in prior art prepaid telephones. The phone number would be assigned 59 at the time of activation to alleviate a potential problem of tying up telephone numbers. The prepaid time usage begins with the answering of the first successfully completed call 57 in optional second or minute increments as determined by the manufacturer 61. All minutes are used as in accordance with existing rules and regulations 62 with applicable roaming deductions made as required 62a. For example, if there are 60 minutes on the prepaid disposable telephone, and the roaming mechanism is activated; the amount of time usage would increase as required by law. Roaming reimbursement would be handled by the appropriate accounting department as in prior art cellular telephone technology. Minutes are deducted for telephone service related calls. Calls to information or other 1-800 calls are charged as required. All minutes built in to the disposable phone must be used within 30 days of activation 64 with possible option allowed as determined by service provider. An example is an option of extension of up to three months as allowed by CSP with an appropriate service fee for allowing the extension 65. Upon completion of usage of minutes or time allotment built into the disposable telephone, the battery and charger are removed for future use and the disposable telephone is disposed of in acceptable manner according to rules and regulations never to be used again 67.

The claims of the invention include:

1. A disposable cellular phone system comprising a system of purchasing a cellular telephone which involves no contract, but is pre-programmed with a predetermined amount of minutes upon which time the minutes are used, the phone is disposed of, never to be used again;
(a) whereas the said phone is capable of being pre-programmed with a code unique to the disposable phone which is linked to a service provider which has a central Data Bank created exclusively for these phones that would be the source of activation upon entry of the specified code of said telephones;
(b) whereas telephone of the invention upon activation is capable of being utilized as a standard cellular phone with roaming capabilities that would result in a higher rate of minute usage when used in roaming conditions as in prior art cellular telephone technology;
(c) invention when used has an optional 911 code with simple activation and standard 911 charges;
(d) whereas phone is ready for activation when enclosed reusable battery is inserted and telephone charged with reusable charger included in original purchase of said telephone of invention;
(e) whereas telephone of invention is assigned a phone number with area code specific to area it is purchased from. The phone number is formulated using prior art base ten system with binary coding added known only by datakeeping system. Upon activation, all the time assigned to the telephone must be used within a specific time period, i.e. one month;
(f) whereas invention has capabilities of using a dual base ten/binary code numbering system, i.e. area code plus standard seven number calling system, plus two or more numbers (base ten or binary) added for additional coding/anti-theft feature.

2. The disposable telephone as set forth in claim 1 has capabilities of unique qualities depending on the particular manufacturing and or servicing contractor, which would include:
(a) Coding;
(b) Materials and housing of said telephone;
(c) Colors or said housing of invention;
(d) Various amounts of time allotted in invention that would affect the cost of each phone;
(e) Roaming capabilities.

3. The disposable phone as set forth in claim 1 utilizes a Central Data Bank with capabilities of encoding/decoding with virtually unlimited variance; whereas the said phone would have built-in anti-theft/minimal loss device due to the disposable nature of the phone which is mentioned in prior art but necessary to the design of the telephone of the invention; i.e. when a phone is purchased, then lost or stolen, only the amount of time built in said phone would be lost, and not the risk of an entire account being plundered;
(a) whereas activating telephone of the invention, the 800 number assigned code given to specific phone is entered, which activates a binary code in the Central Data Bank, which makes theft of minutes virtually impossible;
(b) minutes are then activated and upon completion of first call with answer, the timer begins and time is used in increments of seconds as decided upon by the manufacturer/cellular provider;
(c) whereas possibilities are endless as to the extent of use of said phone which is also mentioned in prior art but necessary to the scope of the telephone of the invention; i.e. replacing conventional cellular phones through such instances as travel, classroom, outdoor activities, emergency standby, and so forth, where the use of a standard cellular telephone is inconvenient or the possibility of theft, loss, or damage high.

4. The disposable phone as set forth in claim 1 would allow individuals to purchase a cellular phone “off the rack” without a contract;
(a) whereas due to minutes of phone time built into the disposable phone, the consumer may simply purchase the unit packaged as a whole and complete phone system, that utilizes the pre-programmed coding and Central Data Bank to activate;
(b) the Central Data Bank of the telephone has the ability to activate minutes preprogrammed into timing mechanism of the telephone of the invention.

5. The disposable phone as set forth in claim 1 would be capable of calling all telecommunication entities whether it be another disposable cellular or wireless telephone, a conventional telephone or other telephonic technology;
(a) whereas invention has prior art technology to use established switching stations, telephone towers, and all technologies in place enabling the use of cellular, digital, or wireless communicators.

6. The disposable phone as set forth in claim 1 would be accessed by consumers through numerous outlets such as retail stores, authorized dealers, convenience stores, gas stations and all authorized access sites;
(a) whereas prepackaged phone would need interaction involved in purchasing any article found in the marketplace and as required by law;
(b) whereas interaction is between the consumer and the provider of the disposable telephone of the invention;
(c) whereas service of the telephone is automated with access available to live customer representatives as in prior art;

7. The disposable phone as set forth in claim 1 utilizes the prior art system of prepaid minutes being assigned to telephones yet minutes may not be added to once they expire on each telephone of the invention, with the exception of possible extension of length of time, i.e. extend time to three months with additional service fee paid through Central Data Bank.

8. The disposable telephone as set forth in claim 1 is individual in nature with no personal information attached to it except as required by law.

9. The disposable telephone as set forth in claim 1 utilizes a system specific to all of the following conditions: disposable telephone specific to the invention, specific coding, specific telephone number recycling, completely disposable with the exception of the reusable charger and battery included in original purchase by consumer.
